(19) United States
(12) Patent Application Publication
(10) Pub. No.: US 2007/0290800 A1
(43) Pub. Date: Dec. 20, 2007

(54) Biometric identification and authentication system using electromagnetic frequency response

(76) Inventor: Milton E. Fuller, Reno, NV (US)

Correspondence Address: DILLON & YUDELL LLP, 8911 N. CAPITAL OF TEXAS HIGHWAY, SUITE 2110, AUSTIN, CA, 78759, US

(21) Appl. No.: 11/447,537

(22) Filed: Jun. 5, 2006

(51) Int. Cl. G05B 19/00

(52) U.S. Cl. 340/5.82; 382/115; 382/124; 250/390.07

(57) ABSTRACT

A method of and a system for using electromagnetic frequency response to identify an unknown individual or authenticate the identity of an individual transmits an electromagnetic signal into a body part of the individual is positioned in a magnetic field. An electromagnetic signal is received from the body part and captured. The frequency spectrum of the captured electromagnetic signal is analyzed to identify, or authenticate the identity of, the individual. Identification is performed by comparing the captured frequency spectrum, or characteristics extracted from the captured frequency spectrum, of the unknown individual to those of known individuals. Authentication is performed by comparing the captured frequency spectrum, or characteristics extracted from the captured frequency spectrum, of an individual to the authentic frequency spectrum, or characteristics extracted from the authentic frequency spectrum, of the individual.

### BACKGROUND OF THE INVENTION

The present invention relates biometric identification and authentication systems and methods, and more particularly to a method of and system for identifying or authenticating the identity of an individual based upon an electromagnetic frequency response spectrum produced by a body part of the individual.

In many fields of activity it is essential that persons be identified or their identities be authenticated. Examples of such fields are well known. Such fields include granting physical access or entry into buildings, rooms or other spaces, and electronic access to information or communication systems. Other fields include authenticating the identity of air travelers and credit card purchasers and ATM customers.

Recently, there have been developed a number of biometric identification and authentication technologies. These technologies operate on the principle that individuals possess unique and unchanging physical characteristics that can be measured and compared with stored data. Examples of current biometric identification and authentication technologies include fingerprint recognition, iris and retina scans, facial recognition, hand geometry, and voice recognition.

Current biometric identification and authentication technologies suffer from drawbacks that have limited their acceptance. Retina and iris scanning technology is highly accurate, but the equipment used in scanning is expensive and it requires substantial space. Fingerprinting has been used for years to identify persons. However, electronic or optical fingerprint scanning systems are expensive and may be inaccurate. Many people consider being fingerprinted an invasion of their privacy. Additionally many fingerprint scanning devices can be “spoofed” rather easily. Voice recognition tends to be less accurate than the other biometric identification and authentication technologies.

### BRIEF SUMMARY OF THE INVENTION

The present invention provides a method of and a system for using electromagnetic frequency response to identify an unknown individual or authenticate the identity of an individual. In an embodiment of the method of the present invention, a body part of an individual is positioned in a magnetic field. A radio frequency (RF) signal having a selected frequency range is transmitted into the body part. An RF signal is received from the body part and captured. The frequency spectrum of the captured RF signal is analyzed to identify the individual.

The method and system of the present invention may be used for identification or authentication. Identification is the process of identifying an unknown individual. Authentication is process of verifying the identity of an individual. Identification is performed by comparing the captured frequency spectrum of the unknown individual to those of known individuals. Authentication is performed by comparing the captured frequency spectrum of an individual to the authentic frequency spectrum of the individual.

Computation and storage requirements may be reduced by extracting from captured frequency spectra characteristics of the frequency spectra. It has been discovered that humans produce a frequency response spectrum that is similar, but not exact, for all individuals. However, each individual's frequency response spectrum is unique. The signal amplitudes at various frequencies vary from individual to individual. Accordingly, the amplitudes of a frequency spectrum may be sampled at selected frequencies. Then authentication or identification may be performed by comparing sampled amplitudes of the unknown individual against those of known individuals. A human frequency response spectrum exhibits a pattern of peaks and valleys that is similar, but not exact, for all individuals. The frequencies at which peaks and valleys occur for an individual are generally shifted higher or lower than the average for the human population. Accordingly, the pattern of peak and valley frequency shifts of an unknown individual may be compared to those of known individuals.

### BRIEF DESCRIPTION OF THE DRAWINGS

FIG. 1 is a block diagram of an embodiment of a biometric security system according to the present invention.

FIG. 2 is a block diagram of an embodiment of an electromagnetic frequency response sensor according to the present invention.

FIG. 3 is a flow chart of an embodiment of electromagnetic frequency response capture and processing according to the present invention.

FIG. 4 is a flow chart of an embodiment of extraction of magnitude as a function of frequency according to the present invention.

FIG. 5 is a flow chart of an embodiment of extraction of frequency shift information according to the present invention.

FIG. 6 is a flow chart of an embodiment of identification according to the present invention.

FIG. 7 is a flowchart of an embodiment of authentication according to the present invention.

FIG. 8 is a diagram of an embodiment of electromagnetic frequency response comparison according to the present invention.

FIG. 9 is a flowchart of an embodiment of sum squared error processing according to the present invention.

FIG. 10 is a flowchart of an embodiment of frequency shift processing according to the present invention.

### DETAILED DESCRIPTION OF THE INVENTION

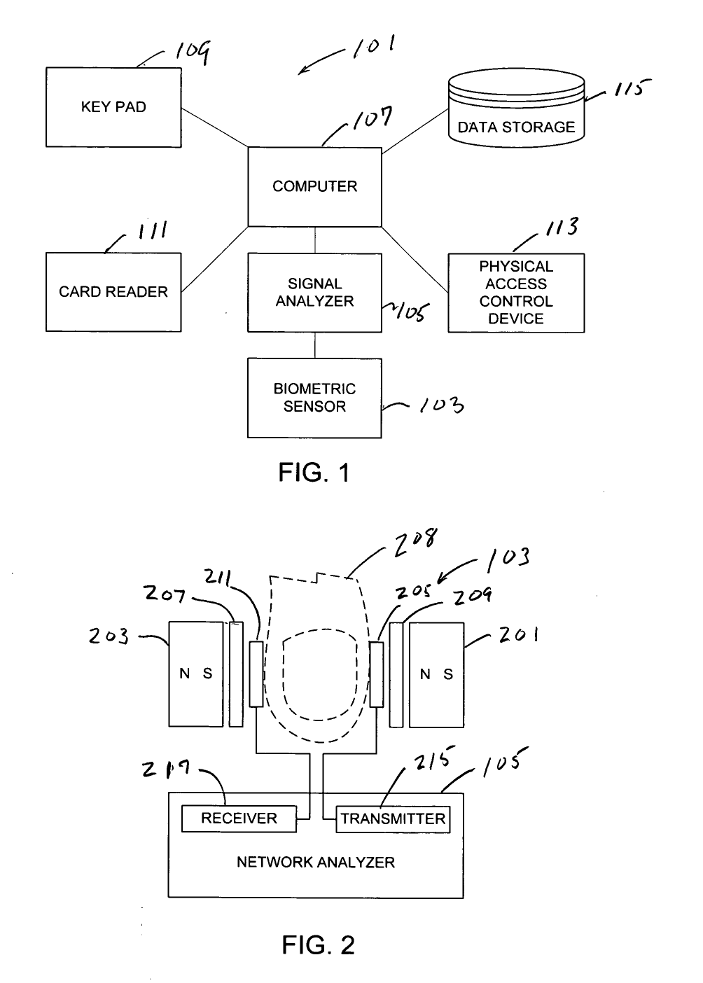

Referring now to the drawings, and first to FIG. 1, an embodiment of a biometric security system according to the present invention is designated generally by the numeral 101. System 101 includes a biometric sensor 103, the structure of which will be described in detail hereinafter, and a signal analyzer 105. Signal analyzer 105 is connected to a computer 107 programmed according to the present invention. Computer 107 may comprise a personal computer, a mini-computer or a large enterprise system computer. System 101 may include peripheral devices such as a keypad 109 or a card reader 111. Computer 107 may be connected to a physical access control device 113, such as an automatic door lock or the like. Computer 107 may be connected to suitable data storage 115.

As shown schematically in FIG. 2, biometric sensor 103 includes two spaced-apart high-gauss permanent magnets 201 and 203, although more than two permanent magnets may be used. Spaced-apart nodes 205 and 207, each comprising an electrically conductive material, are positioned within the magnetic field created by permanent magnets 201 and 203. Preferably each node 205 and 207 is positioned between and in close proximity to a respective magnet 201 or 203. The end of a human finger 208 is shown in phantom positioned between nodes 205 and 207.

In FIG. 2, two nodes 205 and 207 are shown, although multiple transmission nodes and/or reception nodes may be used. Magnets 201 and 203 are aligned such that poles of the magnets are at orthogonal to the alignment of the nodes 205 and 207, with the north pole of magnet 201 facing the south pole of magnet 203. Barriers 209 and 211 may be positioned between magnets 201 and 203 and nodes 205 and 207, as illustrated in FIG. 2. Barriers 209 and 211 are magnetically permeable but electrically insulating, thereby permitting a node to be in close proximity but not in electric contact with a respective magnet.

High-gauss permanent magnets for use in connection with the apparatus of the present invention may include magnets that are preferably from about 26 grade to about 60 grade. The shape of the magnet is not critical. Bar magnets having a round or rectangular cross-section have been used successfully; however, magnets having other shapes, such as disc, cylindrical, torus, etc., may also be used. Neodymium-iron-boron grade 39H/38H bar magnets having a rectangular cross-section may be used.

Biometric sensor 103 is connected to network analyzer 105. As shown in FIG. 2, Network analyzer 105 includes a transmitter 215 coupled to node 205 and a receiver 217 coupled to node 207. Network analyzer 105 may be a commercially available network analyzer, such as an HP8722D Network Analyzer available from Hewlett-Packard Company, Palo Alto, Calif. Transmitter 215 of network analyzer 105 is adapted to sweep over a range of frequencies from 50 MHz to 40 GHz. Network analyzer 105 is adapted to measure the frequency response over the swept range of frequencies of a body part, such as finger 208, positioned between nodes 205 and 207.

The frequency response at certain frequencies is related to a clinical condition, such as blood glucose or hemoglobin A1c level, of a person. These conditions change over time and are not unique to an individual. However, the frequency responses at other frequencies for an individual do not change over time, and are unique to an individual. Accordingly, it is possible according to an embodiment of the present invention to identify an unknown individual by comparing the frequency response spectrum for that unknown individual with the frequency response spectra of known individuals.

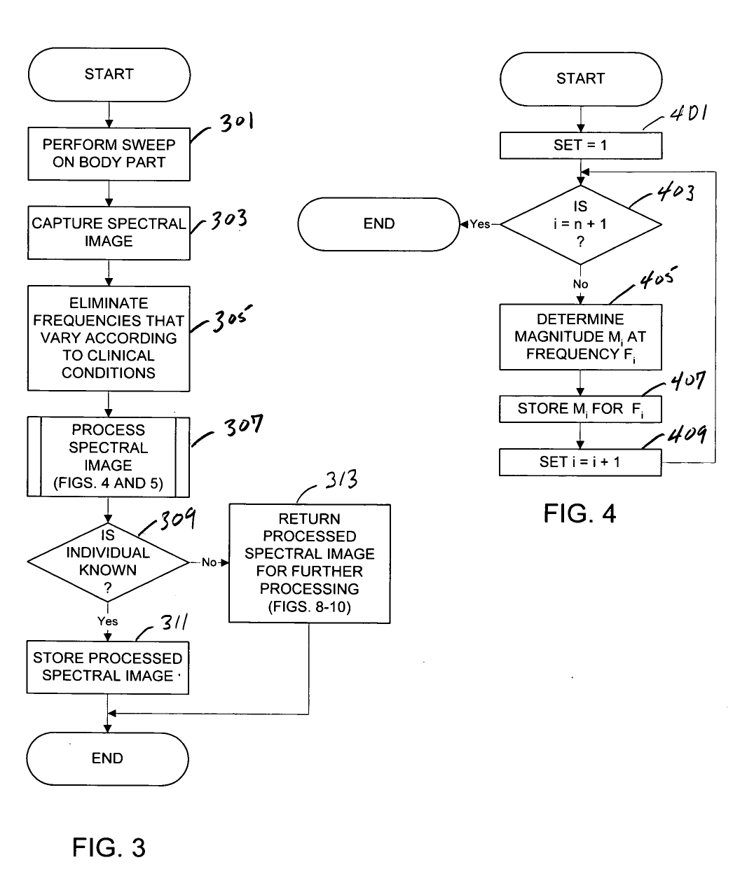

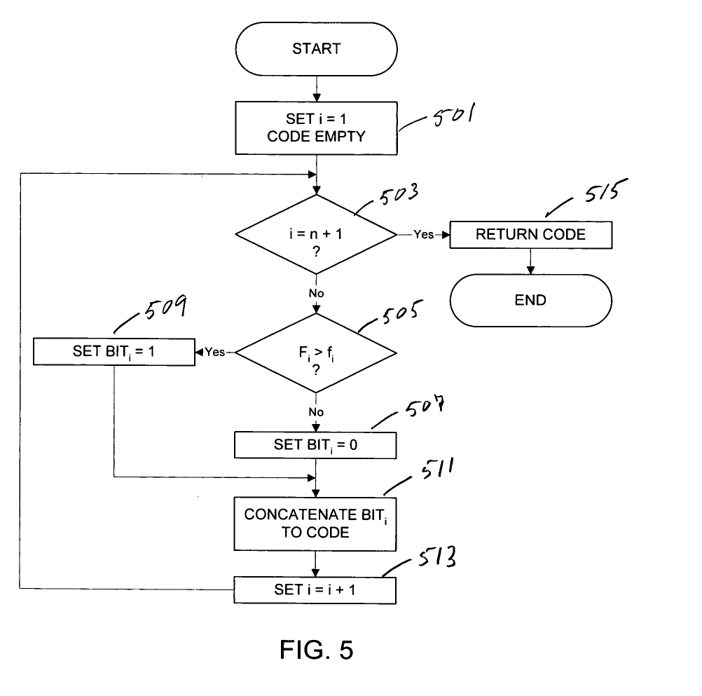

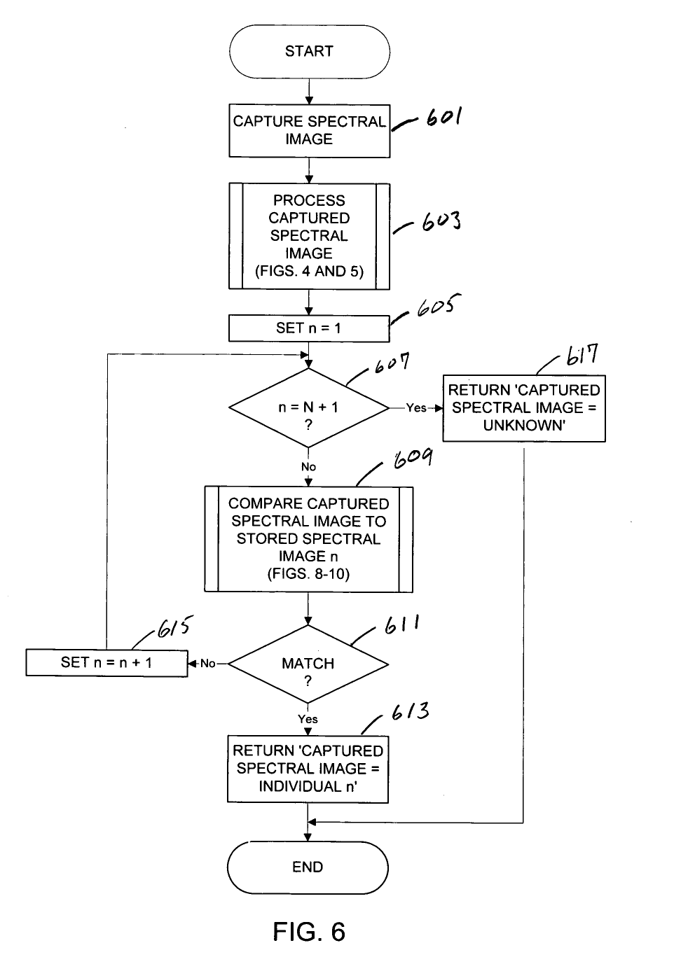

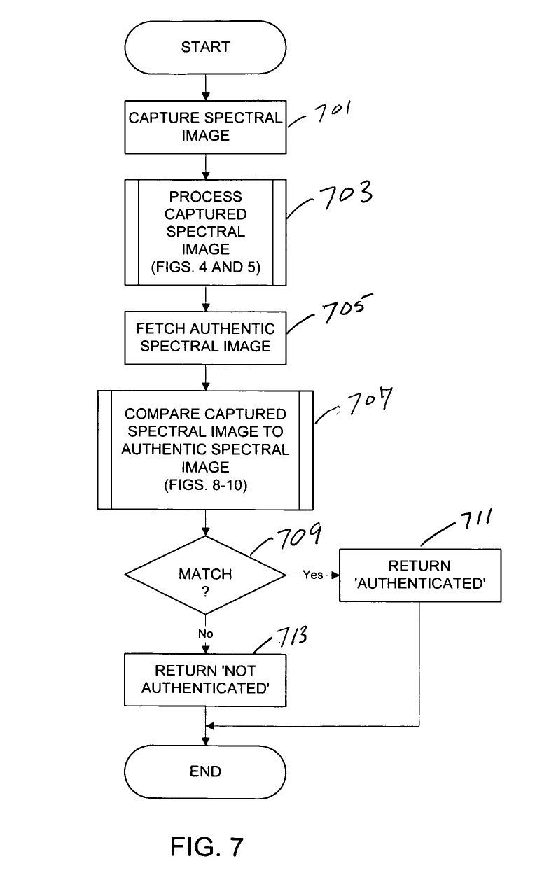

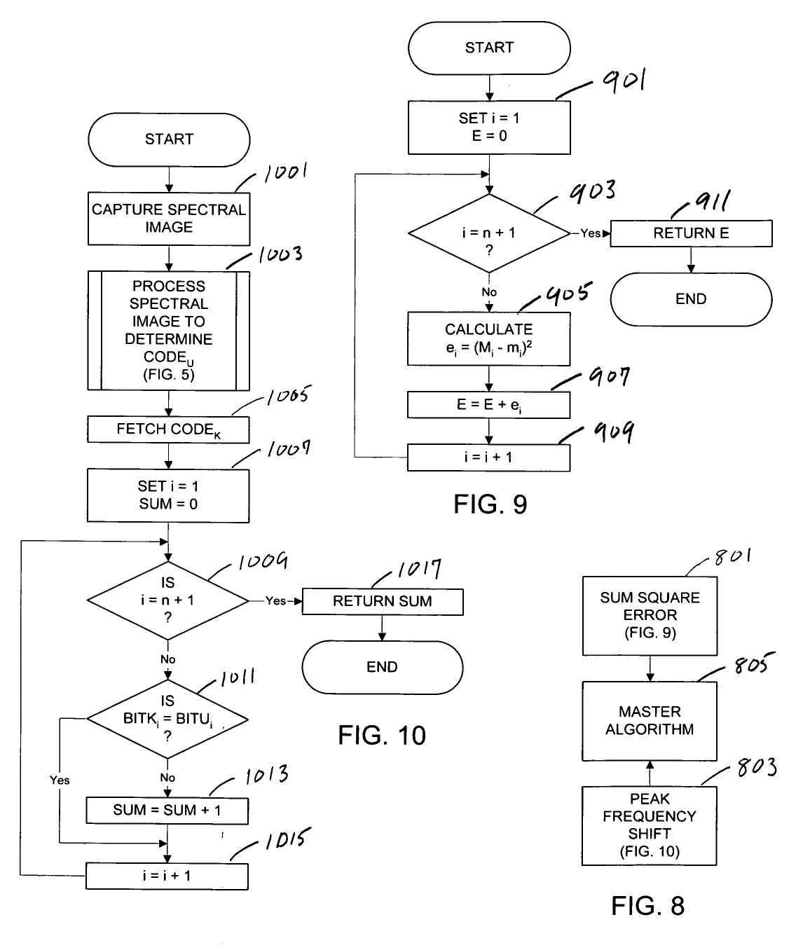

A high level flowchart of spectral image capture according to the present invention is illustrated in FIG. 3. A frequency sweep is performed on a body part at block 301. A spectral image is captured at block 303. Then, frequencies that vary according to clinical condition may be eliminated from the captured spectral image at block 305. Alternatively, the frequencies that vary depending on a clinical condition may be ignored at later steps in processing. Then, the system of the present invention processes the remaining spectral image, as indicated generally at block 307. As will be explained in detail hereinafter in connection with FIGS. 4 and 5, processing of the remaining spectral image typically includes extracting from the spectral image characteristics that make comparison of spectral images easier or more efficient. If, as determined at decision block 309, the processed spectral image is that of a known individual, the processed spectral image may be stored along with identifying data for later use in identifying an unknown individual or for use in authenticating the identity of an individual, as indicated at block 311. Alternatively, if the processed spectral image is of an unknown person, the processed spectral image may be used in identifying or authenticating the identity of the individual from whom the spectral image was captured, as indicated at block 313 and as will be explained in detail hereinafter in connection with FIGS. 8-10.

Examples of spectral image processing according to the present invention include sampling the spectral image to determine response amplitude at selected frequencies and determining the shift of frequencies at which peaks (local maxima) or valleys (local minima) occur in the captured spectral image from the peaks and valleys and valleys of a standard spectral image. It has been discovered that all humans display a characteristic spectral images with peaks and valleys appearing at generally same the frequencies. However, the precise frequency at which a peak or valley occurs may vary from individual to individual. The set of frequencies at which peaks and valleys occur is a characteristic of a particular individual.

An example of a computer implemented method of determining response amplitude at selected frequencies is illustrated in FIG. 4. The system is initialized at block 401 by setting an index i equal to 1. The system tests, at decision block 403 if i is equal n+1, where n is the number of sampled frequencies. If not, the system determines the magnitude Mᵢ of the signal at frequency Fᵢ, at block 405. Then, the system stores Mᵢ, at block 407, sets index i equal to i+1, at block 409, and returns to decision block 403. The system loops through blocks 403-409 until all selected frequencies have been sampled. As alluded to above, the frequencies that correspond to clinical conditions may be ignore during FIG. 4 processing, rather than being eliminated during FIG. 3 processing.

An example of a computer implemented method of determining the variance from a standard the set of frequencies in the spectral image of an individual is illustrated in FIG. 5. The system is initialized at block 501 setting a count i equal to one and a CODE empty. The system determines, at decision block 503, count i is equal to n+1, where n is the number of peaks and valleys in a human spectral image over the domain of frequencies. If not, the system determines, at decision block 505, if a frequency Fᵢ, which is the mean frequency of the ith peak or valley of the standard human frequency response spectrum, is greater than the frequency fᵢ of the ith peak or valley of the captured spectral image. If so, a bit is set equal to 0 at block 507; otherwise, the bit is set equal to 1 at block 509. The bit is then concatenated with CODE, at block 511, the count i is incremented at block 513, and processing returns to decision block 503. FIG. 5 processing loops through blocks 503-513 until count i is equal to n+1, where upon the system returns CODE, as indicated at block 515, for storage in association with a known individual or for further processing. The CODE is a string of bits representing peak frequency shifts of the captured image.

A high level flow chart of identification of an unknown individual is illustrated in FIG. 6. The system of the present invention captures a spectral image from the unknown individual to be identified at block 601. The system then processes the captured spectral image as described with respect to FIGS. 4 and 5, at block 603. The system sets an index n equal to 1 at block 605, and tests whether n=N+1, at block 607, where N is the number of stored spectral images. If not, the system compares extracted characteristics of the captured spectral image to stored characteristics for a known individual n at block 609. Details of the comparison of the extracted characteristics will be discussed in connection with FIGS. 8-10, below. If, as determined at decision block 611, the captured spectral image matches the stored spectral image, the individual is identified as known individual n, at block 613. If not, the index n is incremented at block 615 and processing returns to block 607. FIG. 6 processing continues until an individual is identified or until all stored image characteristics have been compared, as indicated at decision block 607, in which case the individual to be identified is determined to be unidentified, at block 617.

The method and system of the present invention can also be used to authenticate the identity of an individual by comparing characteristics of the frequency response spectrum of a person claiming to be an individual with characteristics of an authentic frequency response spectrum for the individual. A flow chart illustrating authentication according to the present invention is shown in FIG. 7. A spectral image for the individual whose identity is to be authenticated is captured at block 701 and processed as described with reference to FIGS. 4 and 5, as indicated at block 703. Then the authentic spectral image characteristics for the individual are fetched at block 705.

The authentic frequency response spectrum characteristics are preferably stored on computer readable media. For example, in the case of authenticating the identity of a credit card holder, characteristics of the authentic frequency response spectrum may be stored on the credit card itself. Alternatively, characteristics of the authentic frequency response spectrum may be stored in a central data storage that is indexed by the name or other indicia of the individual whose identity is to be authenticated.

Referring still to FIG. 7, after fetching the authentic spectral image characteristics, the system compares the characteristics of the captured spectral image with those of the fetched spectral image characteristics, at block 707. If, as determined at decision block 709, the captured spectral image characteristics match the authentic spectral image characteristics, the individual's identity is authenticated, as indicated at block 711. If the captured spectral image does not match the authentic spectral image, the individual's identity is not authenticated, as indicated at block 703.

The comparison of a captured spectral image with an authentic spectral image is preferably performed by comparing certain characteristics of the captured spectral image with those characteristics of the authentic image. For example, as illustrated in FIG. 8, comparison characteristics may include a sum squared error analysis, indicated generally at block 801, and a frequency shift analysis, indicated generally at block 803. Preferably, the results the analyses 801-803 are processed by a master algorithm, indicated generally at block 805. As will be explained in detail hereinafter, each analysis 801-803 returns to master algorithm 805 a numerical score. The lower the score returned from an analysis 801-803, the more likely the there is a match between the captured spectral image and the authentic spectral image. Master algorithm 805 applies a weighting factor to each score returned from analyses 801-803 and then sums the weighted scores. If the sum of the weighted scores is less than a threshold value, the captured spectral image matches the authentic spectral image.

Sum squared error analysis provides a statistical measure of the degree of quantitative variation between characteristics of the captured spectral image and characteristics of the authentic spectral image. It is based on the square of the difference between two compared magnitudes. The magnitudes of the captured spectral image (mᵢ) and the known spectral image (Mᵢ) are sampled at a plurality of frequencies (n) over their respective bandwidths. The magnitudes of the authentic spectral image are preferably sampled and stored in computer readable media prior to processing of the captured spectral images.

Sum squared error E may be calculated according to the equation

$$E = {\sum }_{i = 1}^{n} {( {M}_{i} - {m}_{i} )}^{2}$$

A computer implemented method of calculating sum squared error is illustrated in the flow chart of FIG. 9. The system is initialized at block 901 by setting a count i equal to one and a score E equal to zero. The system tests at decision block 903 if count i is equal to n+1, where n is number of frequencies sampled. If not, the system calculates a quantity e; which is equal to the square of the difference between the magnitude Mᵢ of the stored spectral image a frequency i and the magnitude mᵢ of the captured spectral image at frequency i, at block 905. The system then sets score E equal to E plus eᵢ, at block 907, and increments count i, at block 909. Processing then continues at decision block 903. FIG. 9 processing continues until count i is equal to n+1, as determined at decision block 903, whereupon the system returns the score E to the master algorithm, as indicated at block 911.

The effect of sum squared error analysis is that smaller variations tend to be disregarded, while larger variations become exaggerated. Consequently, the result is a form of noise filtration: negligible variations due to small variations in measurement are minimized, while significant variations caused by actual mismatches in the data sets are exaggerated. The greater the quantity produced by sum squared error analysis, the less resemblance the captured spectral image has with the authentic spectral image.

Frequency shift analysis according to the present invention is based on the discovery that the spectral images produced by humans have a characteristic pattern of peaks and valleys. The peaks and valleys in the spectral images occur at similar frequencies for all humans. There is a mean or standard frequency for each peak and valley in a human spectral image. However, individuals peaks and valleys may be shifted left (lower frequency) and right (higher frequency) from the mean. The pattern of left and right shifts over the spectral image is a biometric characteristic of an individual.

Referring now to FIG. 10, there is shown a flow chart a computer implementation of frequency shift analysis according to the present invention. A spectral image is captured, at block 1001. Then the captured spectral image is processed according to FIG. 5 to determine a CODE_{U}, as indicated at block 1003. CODE_{U} is the CODE determined for unknown individual U. After determining CODE_{U}, the system fetches CODE_{K}, which is the string of bits representing the peak frequency shift pattern in the image of a known individual K, at block 1005. The system sets a count i equal to one and a SUM equal to zero, at block 1007. The system tests at decision block 1009 if the count i is equal to n+1, where n is the number of bits in CODE_{U} or CODE_{K}. If not, the system compares BITKᵢ, which is ith bit of CODE_{K}, with BITUᵢ, which is the ith bit of CODE_{U}, at decision block 1011. If BITKᵢ is not equal to BITUᵢ, the system sets SUM equal to SUM+1, at block 1013. If BITKᵢ is equal to BITUᵢ, the system bypasses block 1013. The system then increments count i at block 1015 and returns to decision block 147. FIG. 10 processing loops through blocks 1009-1015 until count i is equal to n+1, whereupon SUM is returned to the master algorithm, at block 1017.

Thus, in the illustrated embodiment, SUM is the number of digits of CODE_{U} that differ from CODE_{K}. Accordingly, the lower the value of SUM, the more likely the captured spectral image matches the stored spectral image. Those skilled in the art will recognize that SUM could be calculated to indicate the number of digits of CODE_{U} that are the same as those of CODE_{K}, in which case, the greater the value of SUM, the more likely the captured spectral image matches the stored spectral image.

In operation, a body part, for example, a finger of an individual is placed between the nodes of a biometric sensor. The nodes are positioned between two strong magnets. One of the nodes is coupled to a transmitter. The other node is coupled to a receiver. The transmitter transmits electromagnetic radiation over a range of frequencies into the finger. The receiver receives electromagnetic radiation from the finger. A signal analyzer and a computer capture the frequency response spectrum of the finger. Then, the computer extracts characteristics from the frequency response spectrum. The extracted characteristics may be stored in association with the identity of the individual later use in identifying the individual or authenticating the identity of the individual.

To identify an unknown individual, the individual's body part is swept with electromagnetic radiation and his or her frequency response spectrum is captured. Characteristics of the individual's frequency response spectrum are extracted and compared against those of known individuals, either to identify the individual or authenticate the identity of the individual.

From the foregoing, it may be seen that the method and system of the present of invention are well adapted to overcome the shortcomings of the prior art. The method and system of the present invention provide a reliable, relatively inexpensive, and relatively unobtrusive way to make biometric identification and authentication. Those skilled in the art will recognize alternative embodiments of the invention, given the benefit of the foregoing disclosure. Accordingly, the foregoing disclosure is intended to be for purposes of illustration rather than limitation.

What is claimed is:

1. A method of identifying an unknown individual, which comprises:
positioning a body part of an unknown individual in a magnetic field;
transmitting an electromagnetic signal having a selected frequency range into said body part positioned in said magnetic field;
receiving an electromagnetic signal from said body part positioned in said magnetic field;
capturing a frequency spectrum from the electromagnetic spectrum received from said body part; and,
analyzing the frequency spectrum of the electromagnetic signal received from said body part positioned in said magnetic field to identify said unknown individual.

2. The method as claimed in claim 1, wherein analyzing the frequency spectrum of the electromagnetic signal received from said body part positioned in said magnetic field to identify said individual comprises:
comparing the frequency spectrum of the electromagnetic signal received from said body part positioned in said magnetic field with a frequency spectrum of a known individual.

3. The method as claimed in claim 2, wherein said frequency spectrum of said known individual is stored in computer readable media.

4. The method as claimed in claim 3, wherein said computer readable media comprises a database of frequency spectra of known individuals.

5. The method as claimed in claim 3, wherein said computer readable media comprises portable media carried by said unknown individual.

6. The method as claimed in claim 2, wherein said frequency spectra of said known individuals are stored on computer readable media.

7. The method as claimed in claim 6, wherein said computer readable media comprises a database of frequency spectra of known individuals.

8. The method as claimed in claim 1, wherein analyzing the frequency spectrum of the electromagnetic signal received from said body part positioned in said magnetic field to identify said individual comprises:
eliminating from said frequency spectrum frequencies that are related to medical conditions.

9. The method as claimed in claim 1, wherein analyzing the frequency spectrum of the RF signal received from said body part positioned in said magnetic field to identify said individual comprises:
comparing amplitudes of selected frequencies of said frequency spectrum of the electromagnetic signal received from said body part positioned in said magnetic field with amplitudes of said selected frequencies of a frequency spectrum of a know individual.

10. The method as claimed in claim 9, wherein comparing amplitudes of selected frequencies of said frequency spectrum of the electromagnetic signal received from said body part positioned in said magnetic field with amplitudes of said selected frequencies of a frequency spectrum of a know individual comprises:
determining, for each selected frequency, the difference between the amplitude of for said selected frequency of the frequency spectrum of the unknown individual and the frequency spectrum of the known individual;
squaring each difference; and, summing the squared differences.

11. The method as claimed in claim 1, wherein analyzing the frequency spectrum of the electromagnetic signal received from said body part positioned in said magnetic field to identify said individual comprises:
determining a frequency associated with a local maximum or local minimum amplitude of the frequency spectrum of said unknown individual.

12. The method as claimed in claim 1, including:
determining the frequencies associated with each local maximum and local minimum amplitude of the frequency spectrum of said unknown individual; and,
comparing the frequencies determined for said unknown individuals with frequencies determined for a known individual.

13. The method as claimed in claim 1, wherein said electromagnetic signal is a radio frequency signal.

14. A biometric security system, which comprises:
a biometric sensor, said biometric sensor comprising:
a pair of nodes positioned at spaced apart locations to contact a body part of an unknown person;
a pair of magnets, one of said magnets being positioned adjacent one of said nodes, the other of said magnets being positioned adjacent the other of said nodes;
a transmitter coupled to one of said nodes, said transmitter transmitting an electromagnetic signal having a selected frequency spectrum into said body part positioned in contact with said nodes;
a receiver coupled to the other of said nodes, said receiver receiving an electromagnetic signal received from said body part positioned in contact with said nodes;
means for analyzing the frequency spectrum of the electromagnetic signal received from said body part positioned in contact with said nodes to identify said unknown individual.

15. The biometric security system as claimed in claim 14, wherein said means for analyzing the frequency spectrum of the electromagnetic signal received from said body part positioned in said magnetic field to identify said individual comprises:
means for comparing the frequency spectrum of the electromagnetic signal received from said body part positioned in said magnetic field with a frequency spectrum of a known individual.

16. The biometric security system as claimed in claim 15, wherein said frequency spectrum of said known individual is stored in computer readable media.

17. The biometric security system as claimed in claim 16, wherein said computer readable media comprises a database of frequency spectra of known individuals.

18. The biometric security system as claimed in claim 16, wherein said computer readable media comprises portable media carried by said unknown individual.

19. A biometric detector, which comprises:
a base;
a body part receiver supported by the base;
a pair of nodes positioned at spaced apart locations in the body part receiver to contact a body part positioned in the body part receiver;
a pair of permanent magnets supported by the base, one of said magnets being positioned adjacent one of said nodes, the other of said magnets being positioned adjacent the other of said nodes;
an electromagnetic signal source coupled to one of said nodes, said electromagnetic source being adapted to sweep over a range of frequencies;
a frequency analyzer coupled to the other of said nodes; and,
means for comparing a frequency response spectrum detected by said frequency analyzer with a frequency response spectrum of a known individual.
